(19) United States
(12) Patent Application Publication
(10) Pub. No.: US 2004/0210870 A1
(43) Pub. Date: Oct. 21, 2004

(54) Method of overloading methods in a programming language

(76) Inventors: Richard Friedman, Cherry Hill, NJ (US); Joseph J. Snyder, Shamong, NJ (US); Jason A. Kinner, Marlton, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,981

(22) Filed: Apr. 17, 2003

(51) Int. Cl. G06F 9/44

(52) U.S. Cl. 717/114; 717/118; 717/108

(57) ABSTRACT

The specification may disclose a method of overloading a programming language programs, where a distinction between the overloaded methods are their return parameter types.

### BACKGROUND

Some programming languages may allow method overloading. Method overloading may mean that separate and distinct methods may have the same name. The compiler for the particular programming language may determine which method to invoke based on factors such as the type or number of parameters passed to the method—which may be features of the type signature of the method. For example, consider the following table containing code which may be based on the Java programming language, developed by SUN Microsystems:

TABLE 1

class X{

double X;
double length(double){
// some math operation on a double parameter
}
. . .
double length(int){
// some math operation on an integer parameter
}

}

The exemplary code may define a class, named X, having two methods as members of the class. Each of these methods is named “length,” yet they differ in the parameter list passed to each method: one receives a double type parameter (double defining its range, number of bytes, and the like), and the other method receiving an integer parameter. Invoking one of these two methods may thus take the form “result=x.length(object);”. Depending on the type of parameter of the passed “object,” a compiler may thus select the appropriate method. If “object” has a double parameter type, then the compiler may select the first method of the exemplary Table 1. Likewise, if “object” has an integer parameter type, then the compiler may select the second method of the exemplary Table 1.

### SUMMARY

While some programming languages such as Java may be able to distinguish between methods having the same name but differing parameter lists, they may not have the capability to distinguish between methods having the same name and parameter list, yet differing by return parameter type. That is, some programming language may not inherently support methods whose type signatures differ only by return parameter type.

These problems may be solved in large part by overloading methods of a programming language, wherein a distinction between the overloaded methods is their return parameter types, and wherein the programming language does not support overloading based on return parameter type.

### BRIEF DESCRIPTION OF THE DRAWINGS

For a detailed description of the embodiments of the invention, reference will now be made to the accompanying drawings in which:

FIG. 1 may conceptually illustrate an embodiment of the invention.

### NOTATION AND NOMENCLATURE

Certain terms are used throughout the following description and claims to refer to particular components and systems. As one skilled in the art will appreciate, computer and software companies may refer to a component by different names. This document does not intend to distinguish between components and systems that differ in name but not function. In the following discussion and in the claims, the terms “including” and “comprising” are used in an open-ended fashion, and thus should be interpreted to mean “including, but not limited to . . . ”.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the present invention may be directed to supporting multiple type signatures for a method through a façade pattern. A façade pattern may be considered to be a software wrapper or an abstraction layer for a set of programs. More particularly, embodiments of the invention may be directed to supporting method overloading in Java language programs, where the distinction between methods may only be in the type of parameters returned from the methods.

Java may be a programming language developed by SUN Microsystems that is an object-oriented language similar in syntax to the C programming language. Java may differ from other programming languages in that it does not compile to machine specific code; rather, Java may initially compile to “byte codes,” and these byte codes then may be ported to varying hardware platforms where they may be interpreted by a Java Virtual Machine. Thus, a programmer may be able to write code once, and execute the code on varying hardware platforms, with the Java Virtual Machine for that hardware platform creating the actual machine language instructions. Java may support method overloading based on parameter lists. That is, in Java it may be possible to have multiple methods having the same name, same return parameter type, and different parameter lists. In such a circumstance, the compiler may choose the correct method based on the parameter list. Java, however, may not be able to differentiate overloaded methods based on return parameter type.

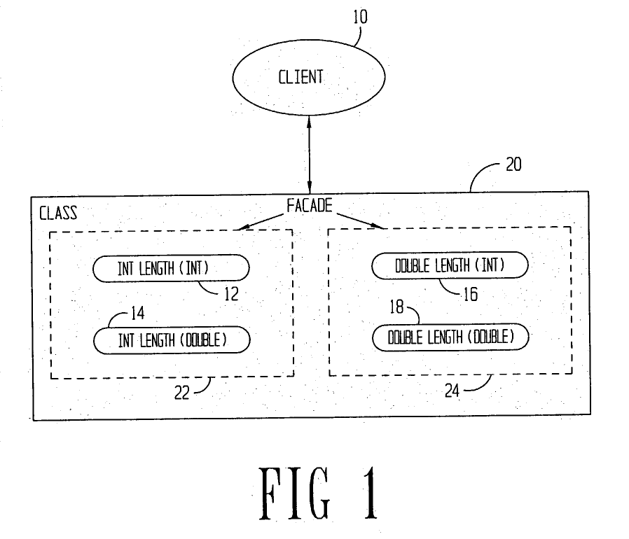

Embodiments of the invention may be directed to using a façade to effectively implement method overloading in Java programming, where the methods may be distinguished based on their return parameter type. FIG. 1 may illustrate embodiments of the invention utilizing the façade for this purpose. In particular, a calling object, labeled a client 10 in FIG. 1, may need to invoke one of several methods sharing the same name. In the illustration of FIG. 1, the methods are each named “length,” implying a method that returns a length parameter; however, the illustration of FIG. 1 should not be construed as limiting applicability of the techniques and methods disclosed herein only to length operations, or to operations bearing only the name “length.” In the exemplary system, the client 10 may need to invoke one of the “length” methods 12, 14, 16 or 18.

In the illustrative system, each of the “length” methods may share a similar name, but may vary in parameter lists (parameters passed to the method from the calling program), and may also vary in return parameter type. In particular, method 12 exemplifies a method having an integer as a passed parameter, and an integer as a return parameter. Method 14 exemplifies a method having a double as a passed parameter, and an integer return type. Method 16 exemplifies a method having a double as a passed parameter, and an integer as a return parameter. Finally, method 18 exemplifies a method having a double as a passed parameter, and a double as a return parameter. Before proceeding, it should be understood that the embodiments of the invention are not limited to operation on methods using only integer and double parameter types. There are -many other passed and return parameter types, such as, without limitation, string, short, long, float, and the like. The techniques and methods of the embodiments of the invention may be equally applicable to methods accepting and returning parameters based on any available parameter types.

In embodiments of the invention, the calling object, for example client 10, needing to invoke one of several overloaded methods distinguishable by return parameter type, may simply call a façade 20. In effect, the fa£ade 20 may select the appropriate overloaded method based on the passed and expected return parameter types. More particularly, embodiments of the invention may be directed to techniques and methods where Java language programs may overload methods distinguishable by return parameter type.

As the illustration of FIG. 1 may imply, the fa£ade 20 may be a class, with the overloaded methods being within subclasses of the façade 20 class. It should be understood, however, that the façade 20 class may itself be a subclass, thus making the sub-classes directly dependent upon the façade 20 sub-subclasses of the root class, and so on.

Because Java may be capable of appropriately selecting overloaded methods based on passed parameter types, in embodiments of the invention the overloaded methods may be broken into subclasses along this line. In FIG. 1 the methods having similar return types are grouped into subclasses: those methods having integer return types in subclass 22, and those having double return types in subclass 24. Java, thus, should be able to distinguish between the overloaded methods within the subclasses based on passed parameter type. In embodiments of the invention, the appropriate subclass may be selected based on class object calling conventions.

Table 2, immediately below, contains exemplary code, based on the Java programming language, that exemplifies embodiments of the invention. It is noted that the exemplary code is not complete: portions that would normally be included but that are not necessarily related to the embodiments of the invention have been omitted for clarity.

TABLE 2

Class facade{

double x;
int y;
. . .

}
Class Engineer extends facade{

. . .
double length(double){
/*a length determination operation on a double parameter,
returning a double*/
}
double length(int){
/*a length determination operation on an integer parameter,
returning a double*/
}

}
Class Estimator extends facade{

. . .
int length(double){
/*a length determination operation on a double parameter,
returning an integer/
}
int length(int){
/*a length determination operation on an integer parameter,
returning an integer*/
}

}

In this exemplary code, a base class, named “façade,” may be created. It is noted that although the class “façade” is so named in this illustration, the class need not actually be named “façade.” This naming convention is only for purposes of illustration, and in actual use any name for the façade class may be used. The illustrative code of Table 2 also exemplifies creation of two subclasses of the “façade” class: namely Engineer and Estimator. Several things should be understood at this point. First, the subclasses of the “façade” class need not be named “Engineer” and/or “Estimator.” The illustrative code of Table 2 uses these names as examples only. The subclasses may have any name, and may, for example only and without limitation, relate to the return types of the overloaded methods of the subclass. Second, the subclasses need not be limited to methods having the same name: the subclasses may contain many overloaded methods. The subclass names illustrated in Table 2 however may exemplify that multiple entities or groups may need, in a broad sense, the same method performed, yet the precise return type may differs.

With those caveats in mind, the illustrative code of Table 2 may show a set of overloaded methods, each bearing the same name, but differing in type signatures. Overloaded methods having the same return parameter type, but differing in passed parameters, may be grouped into a subclass. In the code of Table 2, two such subclasses exist. One subclass named “Engineer” may contain overloaded methods having doubles as return parameter types. Likewise the subclass named “Estimator” may contain overloaded methods having integers as return parameter types. In accordance with embodiments of the invention, Java-language based code may therefore overload methods based not only on passed parameters, but also on parameter return type, while ensuring type-safe method calls. By type-safe, it may be meant that the return type desired may be ensured by calling a method whose return type may match the desired or expected return type.

The use of subclass names of Engineer and Estimator are merely exemplary, and are intended to illustrate, without limitation, one situation where methods may need to be invoked, but different return types may be desired. Engineers, for example, may need to invoke the length methods that return double length parameters, possibly to ensure high accuracy in engineering calculations. Estimators, by contrast, may need to invoke the length methods, but because only rounded figures are needed may only need integer values as return parameters from the length method. Rather than having separately named “length” methods, a façade may be used, with the overloaded methods members of subclass(es) of the façade.

Consider, for purposes of illustration of embodiments of the invention, creation of a new object “X” for use by an Engineer, or a programmer requiring a double length return parameter. The new object may possibly be created by implementing the following line of Java code: “Engineer X=new Engineer( );”. Because the illustrative Engineer is a subclass of the façade class, it may inherit properties, other methods, and the like, from the façade class. Once created however, if a length method needs to be invoked, it may be invoked by implementation of the following code, “X=X.length( );”. Thus, once an object has been created in the proper class, one need not be concerned with finding and calling the exemplary length method that has the proper return parameter, as this may be taken care of by virtue of the class membership. Likewise, one interested only in integer return parameters (for example an Estimator), and needing to invoke the length method, may create an object of the class that returns integers. For example, “Estimator Y=new Estimator( );” and thereafter “Y=Y.length( );”. Here again, the length method in this illustrative case has been overloaded both on passed parameters and return value type, and by virtue of the façade and its subclass, the programmer need not be concerned with picking a method with the correct type signature. Choosing the method with the proper return type may be handled by created an object in the proper class, and Java itself may handle selection of methods overloaded on passed parameters.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising overloading methods of a programming language, wherein a distinction between the overloaded methods is their return parameter types, and wherein the programming language does not support overloading based on return parameter type.

2. The method as defined in claim 1, wherein the programming language is Java.

3. The method as defined in claim 1 further comprising:
making a first method a member of a first class, the first method having a first return parameter type;
making a second method a member of a second class, the second method having a second return parameter type;
creating an object of one of the first and second classes based on a desired return parameter type; and
invoking the method associated with the class of object created.

4. The method as defined in claim 3 further comprising:
making a façade class;
making the first class a subclass of the façade class; and
making the second class a subclass of the façade class.

5. The method as defined in claim 1 further comprising:
making a first plurality of methods as members of a first class, the first plurality of methods each having a same method name, same return parameter types, but having differing passed parameters;
making a second plurality of methods as member of a second class, the second plurality of methods each having a same method name, being the same as the method names of the first plurality of methods, and each of the second plurality of methods having same return parameter types, but having differing passed parameter types;
creating an object of one of the first and second classes based on a desired return parameter type; and
invoking one of the plurality of method associated with the class of object created.

6. The method as defined in claim 5 further comprising:
making a base class;
making the first class a subclass of the base class; and
making the second class a subclass of the base class.

7. A method comprising programming in a programming language a plurality of methods having a same name and passed parameter type, but differing in return parameter type, wherein selecting one of the plurality of methods is based on return parameter type, and wherein the programming language does not support overloading based on return parameter type.

8. The method as defined in claim 7 wherein the programming language is Java.

9. The method as defined in claim 7 further comprising:
making a first method a member of a first class, the first method having first return parameter type;
making a second method a member of a second class, the second method having a second return parameter type;
creating an object of one of the first and second classes based on a desired return parameter type; and
invoking the method associated with the class of object created.

10. The method as defined in claim 7 further comprising:
creating a façade class;
creating first subclass of the façade, the first subclass having member method that returns a first parameter type;
creating a second subclass of the façade, the second subclass having a member method having the same name as the member method of the first subclass, and that returns a second parameter type different than the first parameter type;
creating an object of the one of the first and second subclasses based on a desired return parameter type; and
invoking the member methods associated with the subclass of object created.

11. The method as defined in claim 7 further comprising:
making a first plurality of methods as members of a first class, the first plurality of methods each having a same method name, same return parameter type, but having differing passed parameters;
making a second plurality of methods as member of a second class, the second plurality of methods each having a same method name, being the same as the method names of the first plurality of methods, and each of the second plurality of methods having same return parameter type, but having differing passed parameter types;
creating an object of one of the first and second classes based on a desired return parameter type; and
invoking one of the plurality of method associated with the class of object created.

12. The method as defined in claim 7 further comprising:
creating a base class;
creating first subclass of the base class, the first subclass having a plurality of member methods, each of the plurality of member methods having a same name, a same first return parameter types, and differing in passed parameter types;
creating a second subclass of the base class, the second subclass having a plurality of member methods, each of the plurality of member methods having the same name as the member methods of the first subclass, each of the plurality of member methods having a same second return parameter types different that the first return parameter types, and each of the plurality of member methods differing in passed parameter types;
creating an objection of the one of the first and second subclasses based on a desired return parameter type; and
invoking one of the member methods associated with the subclass of object created.

13. A method comprising using a façade pattern to overload methods in a programming language program whose type-signatures differ only in return parameter type.

14. The method as defined in claim 13 wherein the programming language is Java.

15. The method as defined in claim 13 further comprising:
creating a base class having a first and second subclasses;
creating a first plurality of methods as members of the first subclass, and wherein type signatures of the first plurality of methods each differ only by parameter list; and
creating a second plurality of methods as members of the second subclass, wherein type signatures of the second plurality of methods each differ only by parameter list, and wherein the return types of the second plurality of methods differs from the return types of the first plurality of methods.

16. The method as defined in claim 15 further comprising:
making an object as a member of one of the first and second subclasses, and wherein the subclass selected is based on a desired return type; and
invoking one of the plurality of methods associated with the subclass of object created.

17. The method as defined in claim 13 further comprising:
creating a façade class;
creating a first subclass of the façade class, the first subclass having a first method with a type-signature; and
creating a second subclass of the façade class, the second subclass having a second method with a type-signature that differs from the type signature of the first method by return type.

18. The method as defined in claim 17 further comprising:
making an object as a member of one of the first and second subclasses, and wherein the subclass selected is based on a desired return type; and
invoking one of the plurality of methods associated with the subclass of object created.

19. A computer readable media comprising an executable program, wherein the program comprises a plurality of methods having the same method name and passed parameter list, but differing based on return parameter type, and wherein a programming language of the executable program does not inherently support having methods whose type signatures differ only in return parameter type.

20. The computer readable media as defined in claim 19 wherein the executable program is executable by a Java Virtual Machine.

21. The computer readable media as defined in claim 19 wherein the program further comprises:
a first method as a member of a first class, the first method having first return parameter type;
a second method as a member of a second class, the second method having a second return parameter type; and
an object of one of the first and second classes, the object class based on a desired return parameter type, and wherein the method executed is the method associated with the class of the object.

22. The computer readable media as defined in claim 19 wherein the program further comprises:
a façade class;
a first subclass of the façade, the first subclass having member method that returns a first parameter type;
a second subclass of the façade, the second subclass having a member method having the same name as the member method of the first subclass, and that returns a second parameter type different than the first parameter type;
an object of the one of the first and second subclasses, the object class based on a desired return parameter type, and wherein the member method executed is the method associated with the class of the object.

23. The computer readable media as defined in claim 19 wherein the program further comprises:
a first plurality of methods as members of a first class, the first plurality of methods each having a same method name, same return parameter types, but having differing passed parameters;
a second plurality of methods as member of a second class, the second plurality of methods each having a same method name, being the same as the method names of the first plurality of methods, and each of the second plurality of methods having same return parameter types, but having differing passed parameter types;
an object of one of the first and second classes, the object class based on a desired return parameter type, and wherein one of the first and second plurality of methods is executed, the method selected from the class of the object.

24. The computer readable media as defined in claim 19 wherein the program further comprises:
a base class;
a first subclass of the base class, the first subclass having a plurality of member methods, each of the plurality of member methods having a same name, a same first return parameter types, and differing in passed parameter type;
a second subclass of the base class, the second subclass having a plurality of member methods, each of the plurality of member methods having the same name as the member methods of the first subclass, each of the plurality of member methods having a same second return parameter type different than that of the first return parameter types, and each of the plurality of member methods differing in passed parameter types;
an objection of the one of the first and second subclasses, the subclass of the object based on a desired return parameter type; and
wherein one of the plurality of methods of the first and second subclasses is executed, the method selected from the class of the object.
